(19) United States
(12) Patent Application Publication
(10) Pub. No.: US 2007/0041288 A1
(43) Pub. Date: Feb. 22, 2007

(54) METHODS AND APPARATUSES FOR ACCESSING A HYBRID DISC

(76) Inventors: Ping-Sheng Chen, Chia-Yi Hsien (TW); Shih-Hsin Chen, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/161,820

(22) Filed: Aug. 17, 2005

(51) Int. Cl. G11B 7/00

(52) U.S. Cl. 369/44.26

(57) ABSTRACT

The present invention discloses methods and apparatuses for accessing a hybrid disc. The hybrid disc has a plurality of recording layers corresponding to at least two different storage densities. A proposed method includes acquiring a parameter corresponding to accessing of a target recording layer of the plurality of recording layers, storing the acquired parameter, and when a specific signal is received, performing corresponding servo control operations to access the target recording layer according to the stored parameter.

### BACKGROUND

The present invention relates to optical storage techniques, and more particularly, to methods and apparatuses for accessing a hybrid disc containing multiple recording layers.

Optical discs have become a popular storage medium due to their ease of use, low cost, portability, and high capacity. Various types of optical disc, such as CD (compact disc) and DVD (digital versatile disc), are used for storage in a wide range of fields including video data, audio data, program data, multi-media applications, and many other uses.

In addition to the conventional CD and DVD, there is a proposed type of optical disc different from the conventional discs. The proposed type is termed a hybrid disc. The hybrid disc has multiple recording layers and each recording layer contains a user data area having a particular storage density, wherein at least two different storage densities exist among the user data areas. The conventional hybrid disc is a reproduction-dedicated storage medium such that the physical track layout in the multiple recording layers are mutually the same, for example, the same music piece or the same video program can be recorded in both layers of a dual layer disc. One of the hybrid discs, for example, is a read-only SACD/CD hybrid disc. A typical SACD/CD hybrid disc has two recording layers, one layer for recording high-quality audio signals (audio signals of the SACD format) while the other layer is for recording normal-quality audio signals (audio signals of the CD format). When a SACD player plays the SACD/CD hybrid disc, the SACD/CD hybrid disc is treated as a standard SACD and the music is played by reproducing the high-quality audio signal. On the other hand, when the SACD/CD hybrid disc is played by an ordinary CD player, it is treated as a conventional CD and the music is played by reproducing the normal-quality audio signal.

Another hybrid disc is a read-only BD/DVD hybrid disc, which combines a BD(Blu-Ray Disc) recording layer with a DVD recording layer. The BD/DVD hybrid disc is developed for use in multimedia publishing applications. For example, a high density image can be recorded in the BD recording layer while a standard density image can be recorded in the DVD recording layer so that the BD/DVD hybrid disc is reproducible by any of the many ordinary DVD players or a novel BD player.

In the near future, the hybrid disc will play a more important role in the area of optical storage solutions. There is, therefore, a substantial need for methods and apparatus that improve the accessing efficiency of the hybrid disc.

### SUMMARY OF THE INVENTION

Embodiments of a method for accessing a hybrid disc having multiple recording layers are provided which comprises acquiring a parameter corresponding to accessing of a target recording layer of the multiple recording layers, storing the acquired parameter, and when a specific signal is received, performing corresponding servo control operations to access the target recording layer according to the stored parameter.

Embodiments of an optical storage device for accessing a hybrid disc having multiple recording layers are also provided. In some embodiments, the optical storage device comprises a control circuit for acquiring a parameter corresponding to accessing of a target recording layer of the plurality of recording layers, at least one storage unit coupled to the control circuit for storing the acquired parameter, and a servo module coupled to the control circuit for performing corresponding servo control operations to access the target recording layer according to the stored parameter under the control of the control circuit when a specific signal is received by the control circuit.

Embodiments of an optical storage system for accessing a hybrid disc having multiple recording layers are disclosed. The optical storage system comprises a host circuit for generating a specific signal and an optical storage device. The optical storage device comprises a control circuit coupled to the host circuit for acquiring a parameter corresponding to accessing of a target recording layer, at least one storage unit coupled to the control circuit for storing the acquired parameter, and a servo module coupled to the control circuit for performing corresponding servo control operations to access the target recording layer according to the stored parameter under the control of the control circuit when the specific signal is received.

### BRIEF DESCRIPTION OF THE DRAWINGS

FIG. 1 is a schematic diagram of a hybrid disc.

FIG. 2 is a simplified block diagram of an optical storage system for accessing a hybrid disc according to one embodiment of the present invention.

FIG. 3 is a flowchart illustrating a method for accessing a hybrid disc according to one embodiment of present invention.

### DETAILED DESCRIPTION

The optical disc accessing methods and apparatuses to be described are feasible for use in accessing of various hybrid discs. Note that, the term “hybrid disc” hereinafter specifies that an optical disc having multiple recording layers and each recording layer contains a user data area having a particular storage density, wherein at least two different storage densities exist among the user data areas. The storage densities of the user data areas of a hybrid disc may differ from each other, or some user data areas have a first storage density while the others have a second storage density. Additionally, each of the recording layers of the hybrid disc may be a read-only recording layer or a recordable/re-writable recording layer.

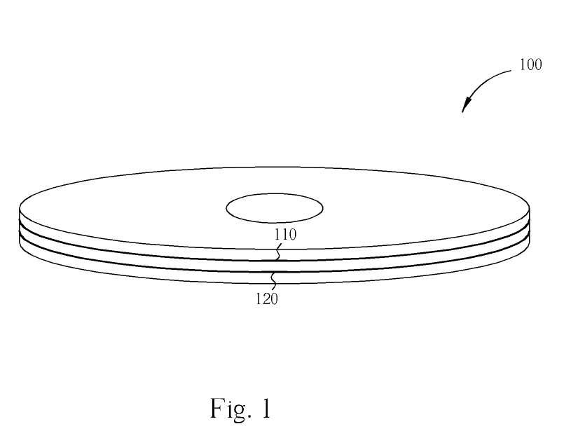

FIG. 1 shows a schematic diagram of a hybrid disc 100. In this embodiment, the hybrid disc 100 comprises a first recording layer 110 corresponding to a first storage density and a second recording layer 120 corresponding to a second storage density. For the purpose of explanatory convenience, the first storage density is assumed higher than the second storage density hereinafter. For example, the first recording layer 110 may be a SACD layer while the second recording layer 120 may be a CD layer.

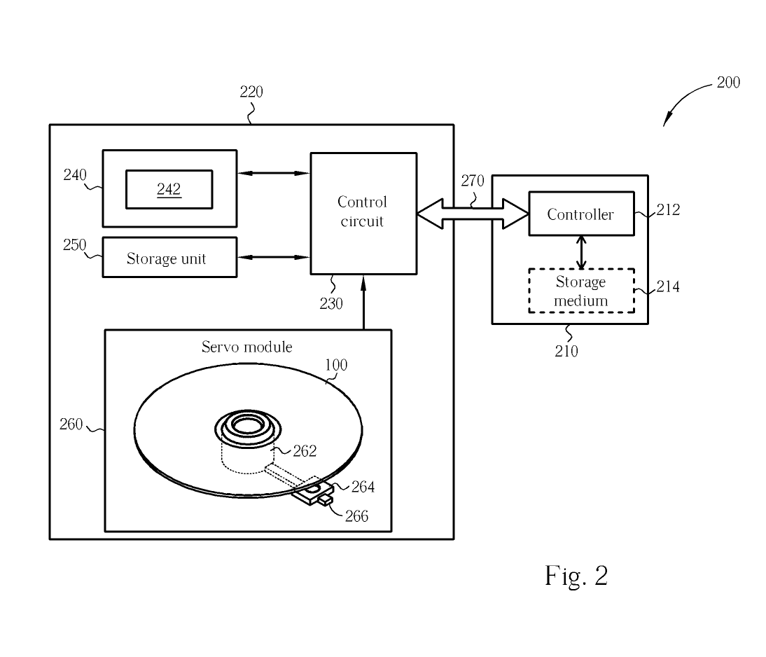

FIG. 2 shows a simplified block diagram of an optical storage system 200 for accessing the hybrid disc 100 according to one embodiment of the present invention. In this embodiment, the optical storage system 200 is capable of accessing each of the recording layers of the hybrid disc 100. The optical storage system 200 comprises a host circuit 210 and an optical storage device 220. The host circuit 210 may be a computer, a controlling chip of an optical disc player/recorder, or any of similar devices. In this embodiment, the optical storage device 220 comprises a control circuit 230 for controlling the operations of the optical storage device 220. As shown, the control circuit 230 is coupled to the host circuit 210 through a communications channel 270. In practice, the communications channel 270 can be implemented with various wired or wireless means. The optical storage device 220 further comprises other components coupled to the control circuit 230, such as a machine readable medium 240, a storage unit 250, and a servo module 260. Such components are described in greater detail below.

In this embodiment, the machine readable medium 240 is arranged for storing executable program instructions 242. Executable program instructions 242 are also referred to as firmware program code. The machine readable medium 240 is generally a non-volatile memory, such as a FLASH, but this is not a restriction of the present invention. The storage unit 250 is arranged for temporarily storing data required for use by the operations of the optical storage device 220. The storage unit 250 may be a memory, a buffer, registers, or other similar items. In practice, the number of storage units employed in the optical storage device 220 is dependent on the design choice and is not limited to a specific number. The servo module 260 typically comprises a spindle motor 262, an optical pickup unit 264, and other mechanical and electrical components. The spindle motor 262 is utilized to rotate the hybrid disc 100. The optical pickup unit 264 slides along a sliding track 266 to access the hybrid disc 100.

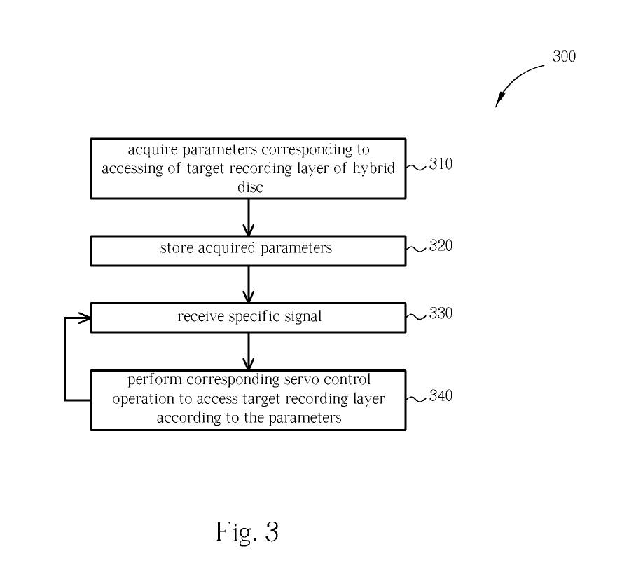

Please refer to FIG. 3, which is a flowchart 300 illustrating a method for accessing the hybrid disc 100 according to one embodiment of present invention.

In step 310, the control circuit 230 acquires parameters corresponding to accessing of a target recording layer of the hybrid disc 100. For the purpose of explanatory convenience in the following description, the second recording layer 120 of the hybrid disc 100 is herein assumed to be the target recording layer. In step 310, the control circuit 230 controls the servo module 260 to access the target recording layer 120 so as to gather parameters for use in accessing of the target recording layer 120, such as a corresponding layer number, a last accessing position of the second recording layer 120, servo control parameters for the servo module 260 and the optical pickup unit 264, or other similar parameters. In practice, the operations of step 310 can be performed during the initialization stage of the hybrid disc 100 that occurs after the hybrid disc 100 is loaded into the optical storage device 220. The control circuit 230 may acquire such parameters for accessing data in different layers at the time that the host circuit 210 makes a request for the optical storage device 220 to change data accessing from one recording layer to another. In some embodiments, these parameters of each layer are determined during the initialization stage by performing servo-on calibration for each layer. In other embodiments, the parameters corresponding to the first layer are obtained after performing the initial servo-on calibration, and the parameters corresponding to each of the remaining layer are obtained when that particular layer is firstly accessed. The optical storage device 220 is then capable of real-time switching from a layer to another.

Next, in step 320, the control circuit 230 stores the acquired parameters in the storage unit 250. In practical implementations, the control circuit 230 can acquire accessing parameters of each recording layer of the hybrid disc 100 in step 310 and stores these parameters in the storage unit 250 in step 320. In other words, the storage unit 250 may merely record the accessing parameters of the second recording layer 120 or record accessing parameters of all recording layers of the hybrid disc 100.

When the user wants to access the second recording layer 120, the host circuit 210 of this embodiment generates a specific signal to the optical storage device 220. The specific signal may be utilized to transmit a predetermined address or a predetermined command to the control circuit 230. For example, the host circuit 210 can request the optical storage device 220 to access the second recording layer 120 by transmitting an address to the control circuit 230 that is beyond the maximum logical address of the first recording layers 110. In practice, the host circuit 210 can achieve the aforementioned task by sending a specific signal to the control circuit 230 through a predetermined signal path, such as a specific pin of the control circuit 230.

In some embodiments, the host circuit 210 comprises at least one storage medium 214 for storing accessing preference settings corresponding to the hybrid disc 100, and a controller 212 coupled to the storage medium 214 and the control circuit 230 for generating the specific signal according to the accessing preference settings. Such accessing preference settings are programmed by the user and may include preferred recording layers of the hybrid disc 100, a default reproducing mode, a preferred data piece, and other similar preference settings.

As a result, when the control circuit 230 receives the specific signal from the host circuit 210 in step 330, the optical storage device 220 accesses the second recording layer 120 of the hybrid disc 100. Accordingly, the control circuit 230 proceeds to step 340 when the specific signal is received.

In step 340, the control circuit 230 controls the servo module 260 to perform corresponding servo control operations with respect to the target recording layer (i.e., the second recording layer 120 in this embodiment) according to the parameters stored in the storage unit 250. Since the parameters corresponding to accessing of the second recording layer 120 had been stored in the storage unit 250, the control circuit 230 can simply load these parameters whereby to control the servo module 260, such as adjusting the focus of the optical pickup unit 264, controlling the rotation speed of the spindle motor 262, performing tracking and focusing control to seek the last accessing position of the second recording layer 120, and so forth. As a result, the latency of servo control operations can be significantly reduced and thereby the efficiency of layer jump of the hybrid disc 100 is significantly improved.

When the optical storage device 220 receives a specific signal commanding the device 220 to read or write data on another layer (for example, the first recording layer 110), the currently accessed address of the second recording layer 120 or other similar parameters is stored, and the servo module 260 performs layer jump using the parameters corresponding to the first recording layer 110. The parameters corresponding to the first recording layer 110 may be acquired at the initialization stage or it may be acquired at the first time the servo module 260 accesses the first recording layer 110. When the optical storage device 220 receives a specific signal commanding the device 220 to jump back to the second recording layer 120 and seamless read/write the data, the optical storage device 220 can perform real-time switching to efficiently access the second recording layer 120 following the position where last layer jump occurs by referring to the parameters and the address stored in the foregoing step 320.

It should be appreciated by those of ordinary skill in the art that the aforementioned methods of accessing the hybrid disc 100 may be implemented by properly programming the executable program instructions 242 stored in the machine readable medium 240.

Note that, the layer jump latency may be further reduced by properly adjusting hardware designs or operational parameters of some components of the servo module 260. The hardware modifications of the servo module 260 are well known in the art, and further details are therefore omitted for brevity.

Certain terms are used throughout the description and following claims to refer to particular system components. As one skilled in the art will appreciate, consumer electronic equipment manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for accessing a hybrid disc having a plurality of recording layers, the method comprising:
acquiring a parameter corresponding to accessing of a target recording layer of the plurality of recording layers;
storing the acquired parameter; and
when a specific signal is received, performing corresponding servo control operations to access the target recording layer according to the stored parameter.

2. The method of claim 1, wherein the parameter is selected from a group consisting of a layer number, a last accessing position, a servo control method, focusing parameters, and tracking parameters corresponding to the target recording layer.

3. The method of claim 1, wherein the specific signal transmits a predetermined address, a predetermined command, or both.

4. The method of claim 1, wherein the steps of performing corresponding servo control operations to access the target recording layer further comprises:
performing tracking and focusing control to seek a last accessing position of the target recording layer according to the stored parameter.

5. An optical storage device for accessing a hybrid disc having a plurality of recording layers, the optical storage device comprising:
a control circuit for acquiring a parameter corresponding to accessing of a target recording layer of the plurality of recording layers;
at least one storage unit coupled to the control circuit for storing the acquired parameter; and
a servo module coupled to the control circuit for performing corresponding servo control operation to access the target recording layer according to the stored parameter under the control of the control circuit when a specific signal is received by the control circuit.

6. The optical storage device of claim 5, wherein the parameter is selected from a group consisting of a layer number, a last accessing position, a servo control method, focusing parameters, and tracking parameters corresponding to the target recording layer.

7. The optical storage device of claim 5, wherein the specific signal transmits a predetermined address, a predetermined command, or both.

8. The optical storage device of claim 5, wherein the control circuit further controls the servo module to seek a last accessing position of the target recording layer according to the stored parameter.

9. An optical storage system for accessing a hybrid disc having a plurality of recording layers, the optical storage system comprising:
a host circuit for generating a specific signal; and
an optical storage device comprising:
a control circuit electrically coupled to the host circuit for acquiring a parameter corresponding to accessing of a target recording layer of the plurality of recording layers;
at least one storage unit electrically coupled to the control circuit for storing the acquired parameter; and
a servo module electrically coupled to the control circuit for performing corresponding servo control operations to access the target recording layer according to the stored parameter under the control of the control circuit when the specific signal is being received by the control circuit.

10. The optical storage system of claim 9, wherein the parameter is selected from a group consisting of a layer number, a last accessing position, a servo control method, focusing parameters, and tracking parameters corresponding to the target recording layer.

11. The optical storage system of claim 9, wherein the specific signal transmits a predetermined address, a predetermined command, or both.

12. The optical storage system of claim 9, wherein the control circuit further controls the servo module to seek a last accessing position of the target recording layer according to the stored parameter.

13. The optical storage system of claim 9, wherein the host circuit comprises:
at least one storage medium for storing an accessing preference setting corresponding to the hybrid disc; and
a controller coupled to the storage medium and the control circuit for generating the specific signal according to the accessing preference setting.
